(19) United States
(12) Patent Application Publication
(10) Pub. No.: US 2008/0302625 A1
(43) Pub. Date: Dec. 11, 2008

(54) WET TYPE FRICTION PLATE

(75) Inventor: Kei TAKAYANAGI, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 12/131,098

(22) Filed: Jun. 1, 2008

(30) Foreign Application Priority Data
Jun. 8, 2007 (JP) 2007-152849

(51) Int. Cl. F16D 13/64

(52) U.S. Cl. 192/107 R

(57) ABSTRACT

The present invention provides a wet type friction plate having a friction surface formed by securing a friction material to a substantially annular core plate in an annular fashion, in which the friction surface is provided with a plurality of first recessed portion each including an opening portion opened to an inner diameter side and an end portion closed between inner and outer diameter sides of the friction material and a plurality of second recessed portions each including an opening portion opened to the outer diameter side and an end portion closed between the inner and outer diameter sides of the friction material, and the first recessed portions and the second recessed portions are arranged alternately along a circumferential direction, wherein each of said first recessed portions and said second recessed portions has a maximum circumferential width at said opening portion.

### BACKGROUND OF THE INVENTION

1. Field of the Invention

The present invention relates to a wet type friction plate used in a speed change clutch, a lock-up clutch for a torque converter, a wet type multi-plate clutch for a starting clutch and the like utilized in a clutch or a brake and the like of an automatic transmission (AT) of a vehicle.

2. Related Background Art

In general, in a wet type multi-plate clutch, friction plates and separator plates are disposed alternately between a drum and a hub of a clutch or a brake so that the clutch is engaged and disengaged by applying to and releasing from a pressing force with respect to the plates by means of a clutch piston, respectively.

Further, in recent years, low fuel consumption of a motor vehicle has been requested more and more, and, also in an automatic transmission, reduction in drag torque between the friction plate and the separator plate has been requested more and more in order to reduce power loss during the engagement of the clutch.

A wet type multi-plate clutch including paper friction materials has advantages that transmission torque can be controlled by adjusting a load applied to a friction surface and that smooth engagement can be achieved during transmission of the torque and is mainly used in a speed change device of the automatic transmission, a torque converter, a starting clutch and the like.

In general, in many cases, a wet type multi-plate clutch used in an automatic transmission (AT) is designed so that lubricant oil can easily be flown from an inner peripheral side to an outer peripheral side of the friction plate, thereby reducing the drag torque. Such arrangements for reducing the drag torque are known, for example, as disclosed in Japanese Patent Application Laid-open Nos. 11-141570 (1999) and 2005-76759. In the clutches disclosed in the Japanese Patent Application Laid-open Nos. 11-141570 (1999) and 2005-76759, a friction plate is provided with oil grooves each having a closed end at an inner peripheral side to separate the friction plate and the separator plate during the disengagement and oil passages extending through from an inner periphery to an outer periphery in a radial direction and adapted to supply oil in order to prevent seizure during the engagement by supplying the lubricant oil to the friction surfaces.

However, in recent years, in order to improve speed change response so as to enhance power performance as well as the reduction in fuel consumption, a clearance between the friction plate and the separator plate has been made narrower than that in the prior art, with the result that the drag torque has tended to increase during an idle rotation due to the presence of the interposed oil film.

Further, in order to meet the requirement for reducing the fuel consumption, recently, as a countermeasure for providing an automatic transmission of compact size and/or multi-stage type and providing an oil pump of compact size and achieving excellent efficiency by reducing drag torques of sliding elements, the friction plate used in the automatic transmission has been designed to be used with a higher rotation and a smaller amount of the lubricant oil, and thus, a wet type friction plate having greater heat resistance has been requested in the case where the friction plate is used with the smaller amount of the lubricant oil and the higher rotation.

Although the oil from the oil groove extending through from the inner periphery to the outer periphery in the radial direction is used to supply the oil to the friction surface and to discharge the oil, the flow of the oil from the oil groove to the friction surface is greatly influenced by a configuration of the oil groove and the like, with the result that the oil flow affects an influence upon the idle rotation torque and the friction property during the engagement, thereby causing dispersion in plate quality.

In the clutches as disclosed in the above-mentioned Japanese Patent Application Laid-open Nos. 11-141570 (1999) and 2005-76759, the oil grooves each having the closed end to separate the friction plate and the separator plate during the disengagement and the oil passages extending through from the inner periphery to the outer periphery in the radial direction and adapted to supply the oil in order to prevent the seizure during the engagement by supplying the lubricant oil to the friction surfaces are provided in certain friction plates.

Regarding the friction materials of these friction plates, although the oil from the oil groove extending through from the inner periphery to the outer periphery in the radial direction is used to supply the oil to the friction surface and to discharge the oil, the flow of the oil from the oil groove to the friction surface is greatly influenced by the configuration of the oil groove and dull both side corners of the groove, with the result that the oil flow affects an influence upon the idle rotation torque and the friction property during the engagement, thereby causing dispersion in plate quality. In the conventional friction plates, in order to meet the requirements for compactness and light-weight which should be achieved in the recent transmissions, it has been desired to increase friction capacity of each friction plate. To this end, the increase in the number of grooves to be formed in the friction plate and the size of the groove have been limited or restricted severely.

### SUMMARY OF THE INVENTION

Accordingly, an object of the present invention is to provide a wet type friction plate in which a coefficient of friction during an idle rotation is small in all of rotating areas or regions.

To achieve the above object, the present invention provides a wet type friction plate having a friction surface formed by securing a friction material to a substantially annular core plate in an annular fashion, in which the friction surface is provided with a plurality of first recessed portions each including an opening portion opened to an inner diameter side and an end portion closed between inner and outer diameter sides of the friction material and a plurality of second recessed portions each including an opening portion opened to the outer diameter side and an end portion closed between the inner and outer diameter sides of the friction material, and the first recessed portions and the second recessed portions are disposed alternately in a circumferential direction, and wherein each of said first recessed portions and said second recessed portions has a maximum circumferential width at said opening portion.

According to the present invention, the following effects can be obtained.

Since the friction surface of the friction material is provided with the plurality of first recessed portions each including the opening portion opened to the inner diameter side and the end portion closed between the inner and outer diameter sides of the friction material and the plurality of second recessed portions each including the opening portion opened to the outer diameter side and the end portion closed between the inner and outer diameter sides of the friction material, drag during the idle rotation can be reduced in all of rotating areas from low speed rotation to high speed rotation.

The plurality of first recessed portions each including the opening portion opened to the inner diameter side and the end portion closed between the inner and outer diameter sides of the friction material serve to generate oil flow for returning the oil in the first recessed portions to the inner diameter side by actions of wall surfaces of the recessed portions and interaction of oil viscosity caused by a rotational difference between the friction plate and the separator plate, during the low speed idle rotation. Thus, positive pressure is generated in the first recessed portion which generates a force for separating the friction plate and the separator plate from each other, thereby preventing the seizure between the friction plate and the separator plate and reducing the excessive supplying of oil to the friction material and reducing the drag torque between the friction surfaces.

Further, the plurality of second recessed portions each including the opening portion opened to the outer diameter side and the end portion closed between the inner and outer diameter sides of the friction material serve to generate a force for discharging the oil in the recessed portions outside by actions of wall surfaces of the recessed portions and interaction of oil viscosity caused by a rotational difference between the friction plate and the separator plate, thereby positively discharging the oil supplied to the friction surface to the outer diameter side through the opening portions. In this way, since the oil can be discharged from the friction surface quickly, the drag during the idle rotation can be reduced.

Further, in the high speed idle rotation, the amount of oil discharged from the second recessed portions having the opening portions opened to the outer diameter side is more increased to generate negative pressure in the recessed portions, so that air is sucked into the recessed portions from the outer diameter side, and the sucked air is supplied to the friction surface, where the air is mixed with the oil on the friction surface, thereby reducing the idle rotation drag more greatly.

Further features of the present invention will become apparent from the following description of exemplary embodiments with reference to the attached drawings.

### BRIEF DESCRIPTION OF THE DRAWINGS

FIG. 1 is an axial partial sectional view of a wet type multi-plate clutch to which embodiments of a wet type friction plate of the present invention can be applied.

FIG. 2 is a front view of a wet type friction plate according to a first embodiment of the present invention.

FIG. 3 is a front view of a wet type friction plate according to a second embodiment of the present invention.

FIG. 4 is a front view of a wet type friction plate according to a third embodiment of the present invention.

FIG. 5 is a front view of a wet type friction plate according to a fourth embodiment of the present invention.

### DETAILED DESCRIPTION OF THE INVENTION

Now, the present invention will be fully explained with reference to the accompanying drawings. Incidentally, in the drawings, the same parts or elements are designated by the same reference numerals.

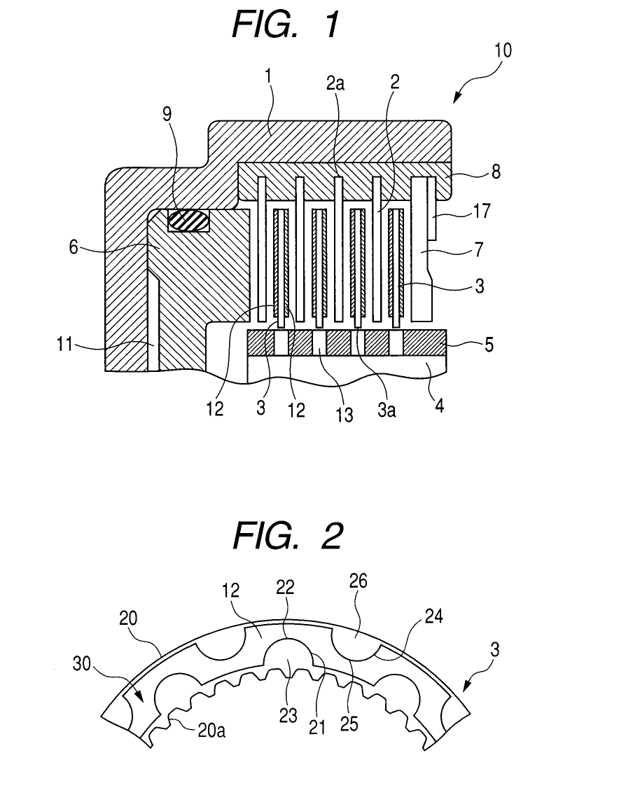

FIG. 1 is an axial partial sectional view of a wet type multi-plate clutch 10 to which embodiments of a wet type friction plate of the present invention can be applied.

The wet type multi-plate clutch 10 comprises a substantially cylindrical drum or clutch case 1 having an opened axial one end, a hub 4 disposed coaxially within the clutch case 1 and rotatable relative to the clutch case, annular separator plates 2 disposed, for an axial movement, in a spline portion 8 provided on an inner periphery of the clutch case 1, and annular friction plates 3 disposed in a spline portion 5 provided on an outer periphery of the hub 4 and arranged alternately with the separator plates 2 in an axial direction, and, friction materials 12 are adhered to the friction plates. Plural separator plates 2 and plural friction plates 3 are provided.

The wet type multi-plate clutch 10 includes a piston 6 for pressing the separator plates 2 and the friction plates 3 to engage these plates with each other, a backing plate 7 provided on the inner periphery of the clutch case 1 to fixedly hold the separator plates 2 and the friction plates 3 at an axial one end of the clutch, and a stop ring 17 for holding the backing plate.

As shown in FIG. 1, the piston 6 is disposed within a closed end portion of the clutch case 1 for an axial sliding movement. An O-ring 9 is disposed between an outer peripheral surface of the piston 6 and an inner surface of the clutch case 1. Further, a seal member (not shown) is also provided between an inner peripheral surface of the piston 6 and an outer peripheral surface of a cylindrical portion (not shown) of the clutch case 1. Accordingly, an oil-tight hydraulic chamber 11 is defined between an inner surface of the closed end portion of the clutch case 1 and the piston 6.

In each of the friction plate 3 held by the hub 4 for the axial sliding movement, friction materials 12 having predetermined coefficient of friction are stuck to both surfaces of the friction plate. However, the friction material 12 may be provided on only one surface of the friction plate 3 and/or the separator plate 4. Further, the hub 4 is provided with lubricant oil supplying ports 13 extending through in a radial direction so that lubricant oil is supplied from an inner diameter side to an outer diameter side of the wet type multi-plate clutch 10.

In the wet type multi-plate clutch 10 having the above-mentioned arrangement, the clutch is tightened or engaged and released or disengaged in the following manner. A condition shown in FIG. 1 is a clutch released condition in which the separator plates 2 are separated from the wet type friction plates 3. In the released condition, the piston 6 abuts against the closed end portion of the clutch case 1 by a biasing force of a return spring (not shown).

From this condition, in order to tighten or engage the clutch, oil pressure is supplied to the hydraulic chamber 11 defined between the piston 6 and the clutch case 1. As the oil pressure is increased, the piston 6 is shifted to the right in FIG. 1 in the axial direction in opposition to the biasing force of the return spring (not shown), thereby closely contacting the separator plates 2 with the wet type friction plates 3.

After the engagement, in order to release the clutch again, the oil pressure is released from the hydraulic chamber 11. When the oil pressure is released, by the biasing force of the return spring (not shown), the piston 6 is shifted until it abuts against the closed end portion of the clutch case 1. In this way, the clutch is released or disengaged.

### FIRST EMBODIMENT

FIG. 2 is a front view of a wet type friction plate according to a first embodiment of the present invention. The wet type friction plate 3 has a friction surface 30 formed by sticking a substantially annular friction material 12 to a substantially annular core plate 20 by an adhesive and the like. The core plate 20 is provided at its inner periphery with splines 20a adapted to be engaged by the spline portion 5 of the hub 4.

As shown, a plurality of first recessed portions 21 and a plurality of second recessed portions 24, which are equidistantly spaced apart from each other along a circumferential direction and are disposed alternately, are formed in the friction material 12. The plurality of first recessed portions 21 each having an opening portion 23 opened to an inner diameter side and an end portion 22 closed between inner and outer diameter sides of the friction material 12 and the plurality of second recessed portions 24 each having an opening portion 26 opened to the outer diameter side and an end portion 25 closed between the inner and outer diameter sides of the friction material 12 are constituted by semicircular recesses having same size, but the opening portions are staggered in the radial direction.

Both of the first recessed portion 21 and the second recessed portion 24 have maximum circumferential widths at the opening portion 23 and the opening portion 26, respectively. Here, since the recessed portion is semicircular, the maximum circumferential width corresponds to a diameter. Further, it is preferable that a radial length (distance from the opening portion to the closed end portion) of each of the first recessed portion 21 and the second recessed portion 24 is greater than ⅓ of a radial width of the friction material 12.

In the illustrated embodiment, although eight or more first and second recessed portions 21 and 24 are provided along the circumferential direction (whole periphery) respectively, it should be noted that the number of the respective recessed portions may be selected voluntarily on the basis of idle rotation conditions such as operating face pressure, a rotating condition and an oil amount. Further, the number of the first recessed portions 21 and the number of the second recessed portions 24 may be differentiated. However, it is preferable that these recessed portions are disposed equidistantly along the circumferential direction.

In the illustrated embodiment, both of the first recessed portions 21 and the second recessed portions 24 are formed by punching the friction material 12 before the friction material is secured to the friction plate. Accordingly, at the first recessed portions 21 and the second recessed portions 24, the core plate 20 is exposed.

### SECOND EMBODIMENT

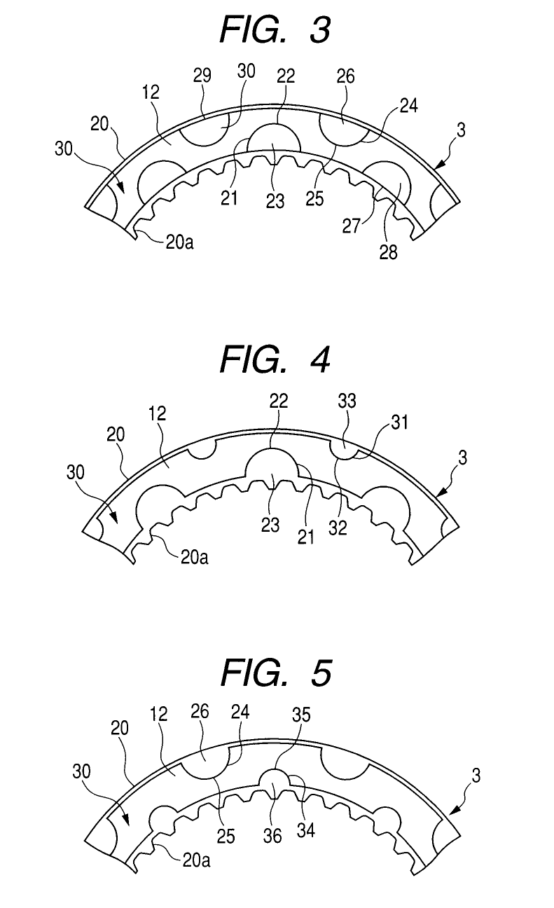

FIG. 3 is a front view of a wet type friction plate according to a second embodiment of the present invention. Although a fundamental construction of the third embodiment is the same as that of the first embodiment, a method for forming the first recessed portions 21 and the second recessed portions 24 differs from that of the first embodiment. Accordingly, only the difference will be described.

In the first embodiment, although the friction material 12 in which the first recessed portions 21 and the second recessed portions 24 were previously formed by the punching are secured to the core plate 20, in the second embodiment, the first recessed portions 21 and the second recessed portions 24 are formed by press-forming such recessed portions in the annular friction material 12 secured to the core plate 20.

As shown in FIG. 3, an inner peripheral edge 27 of the friction material 12 remains at the opening portion 23 of the first recessed portion 23 and a bottom surface 28 of the friction material 12 press-formed is defined within the first recessed portion 21. Further, similarly, an outer peripheral edge 29 of the friction material 12 remains at the opening portion 26 of the second recessed portion 24 and a bottom surface 30 of the friction material 12 press-formed is defined within the second recessed portion 24. That is to say, in the second embodiment, the core plate 20 is not exposed within the first recessed portions 21 and the second recessed portions 24.

### THIRD EMBODIMENT

FIG. 4 is a front view of a wet type friction plate according to a third embodiment of the present invention. The third embodiment is an alteration of the first embodiment, in which sizes of recessed portions differ from each other at inner and outer diameter sides of the friction material 12.

A first recessed portion 21 disposed at the inner diameter side is the same as that of the first embodiment. In the third embodiment, as shown in FIG. 4, second recessed portions 31 disposed at the outer diameter side differ from those of the first embodiment. Each of the plurality of second recessed portions 31 has an opening portion 33 opened to the outer diameter side and an end portion 32 closed between the inner and outer diameter sides of the friction material 12.

Both of a circumferential width and a radial length of the opening portion of the second recessed portion 31 are smaller than those of the first recessed portion 21. This arrangement is effective in a case where increase in an amount of oil discharged from the outer diameter side is not desired and an area of the friction surface 30 is desired to be increased.

### FOURTH EMBODIMENT

FIG. 5 is a front view of a wet type friction plate according to a fourth embodiment of the present invention. The fourth embodiment is an alteration of the first embodiment, in which sizes of recessed portions differ from each other at inner and outer diameter sides of the friction material 12 and an arrangement reverse to the third embodiment is adopted.

A second recessed portion 24 disposed at the outer diameter side is the same as that of the first embodiment. In the fourth embodiment, as shown in FIG. 5, first recessed portions 34 disposed at the inner diameter side differ from those of the first embodiment. Each of the plurality of first recessed portions 34 has an opening portion 36 opened to the inner diameter side and an end portion 35 closed between the inner and outer diameter sides of the friction material 12.

Both of a circumferential width and a radial length of the opening portion of the first recessed portion 34 are smaller than those of the second recessed portion 24. This arrangement is effective in a case where increase in an amount of oil returned to the inner diameter side is not desired and an area of the friction surface 30 is desired to be increased.

According to the third and fourth embodiment, in the high speed idle rotation, idle rotation drag can be reduced greatly, by mixing air sucked onto the friction surface with the oil on the friction surface.

Also in the above-mentioned third and fourth embodiments, similar to the second embodiment, the first recessed portions 21 and the second recessed portions 31 (third embodiment) and the first recessed portions 34 and the second recessed portions 24 (fourth embodiment) may be formed by press-forming them on the annular friction material 12 secured to the core plate 20.

In the above-mentioned embodiments, it is preferable that the circumferential width of the recessed portion is maximized at the opening portion opened to the outer or inner diameter side.

Further, although the embodiments in which the annular friction material is used were explained, a plurality of friction material segments may be secured to the core plate in an annular fashion. In order to secure the annular friction material or friction material segments to the core plate, an adhesive is coated on the core plate and then the friction material or friction material segments are pressed against the core plate with heat and pressure. However, a seal-type friction material having a rear surface on which an adhesive was previously coated can be used.

The number of the first recessed portions may be the same as or differ from the number of the second recessed portions. However, it is preferable that the recessed portions are provided equidistantly along the circumferential direction. The number of the recessed portions can be determined in consideration of face pressure and the like during the operation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-152849, filed Jun. 8, 2007, which is hereby incorporated by reference in its entirety.

What is claimed is:

1. A wet type friction plate having a friction surface formed by securing a friction material to a substantially annular core plate in an annular fashion,
wherein said friction surface is provided with a plurality of first recessed portions each including an opening portion opened to an inner diameter side and an end portion closed between inner and outer diameter sides of said friction material and a plurality of second recessed portions each including an opening portion opened to the outer diameter side and an end portion closed between the inner and outer diameter sides of said friction material, and said first recessed portions and said second recessed portions are disposed alternately along a circumferential direction, and
wherein each of said first recessed portions and said second recessed portions has a maximum circumferential width at said opening portion.

2. A wet type friction plate according to claim 1, wherein each of said first recessed portions and said second recessed portions has a semicircular configuration.

3. A wet type friction plate according to claim 2, wherein a radial length of each of said first recessed portions and said second recessed portions is greater than ⅓ of a radial width of said friction material.

4. A wet type friction plate according to claim 1, wherein the numbers of said first recessed portions and said second recessed portions provided along the circumferential direction are eight or more, respectively.

5. A wet type friction plate according to claim 1, wherein said first recessed portions and said second recessed portions have different diameters.

6. A wet type friction plate according to claim 1, wherein friction materials are secured to both axial surfaces of said core plate.

7. A wet type friction plate according to claim 1, wherein said first recessed portions and said second recessed portions are formed by press-forming said portions in said friction material.

8. A wet type friction plate according to claim 1, wherein said first recessed portions and said second recessed portions are previously punched in said friction material.
